(19) United States
(12) Patent Application Publication
(10) Pub. No.: US 2013/0262181 A1
(43) Pub. Date: Oct. 3, 2013

(54) METHODS AND APPARATUS TO PREDICT AUDIENCE COMPOSITION AND/OR SOLICIT AUDIENCE MEMBERS

(71) Applicants: Alexander Topchy, New Port Richey, FL (US); Padmanabhan Soundararajan, Tampa, FL (US); Arun Ramaswamy, Tampa, FL (US)

(72) Inventors: Alexander Topchy, New Port Richey, FL (US); Padmanabhan Soundararajan, Tampa, FL (US); Arun Ramaswamy, Tampa, FL (US)

(21) Appl. No.: 13/436,057

(22) Filed: Mar. 30, 2012

(51) Int. Cl. G06Q 30/02

(52) U.S. Cl. CPC G06Q 30/0202
USPC 705/7.31

(57) ABSTRACT

Methods and apparatus to predict audience composition and solicit audience members are disclosed. A method to predict audience composition for future media involves obtaining indications of intent from first audience members to consume first media, determining a portion of the first audience members that were actually exposed to the first media, and predicting audience composition for a second media of second audience members based on the portion of the first audience members.

### FIELD OF THE DISCLOSURE

This patent relates generally to audience measurement and, more particularly, to predicting audience composition and/or soliciting audience members.

### BACKGROUND

Exposure to and/or consumption of media (e.g., television media, radio media, Internet media, and/or other forms of media) is often measured to determine audience size, audience demographics, and/or other audience characteristics. Some known audience measurement techniques involve surveying a sample population of audience members (e.g., a panel) while, and/or after, they are exposed to and/or consume media (e.g., content and/or advertisements). Data collected from such surveys is extrapolated to estimate an overall audience population and/or characteristics thereof. Content providers, broadcasters, advertisers, and/or other entities use audience measurement information (e.g., ratings) to determine the success of their media, to select placement of media and/or to determine pricing for broadcast or other media.

### BRIEF DESCRIPTION OF THE DRAWINGS

FIG. 1 is an example system constructed in accordance with the teachings disclosed herein to predict audience composition and/or to solicit audience members.

FIG. 2A illustrates an example manner of implementing the example intent indicator 114 of FIG. 1.

FIG. 2B illustrates another example manner of implementing the example intent indicator 114 of FIG. 1.

FIG. 3 illustrates example methods of verifying actual exposure to and/or consumption of media.

FIG. 4 is an example distribution graph illustrating how media exposure consistency indices may vary among audience members.

FIG. 5 is an example prediction apparatus to predict audience composition of future media and/or to solicit audience members to consume media in connection with the system of FIG. 1.

FIG. 6 is a flow diagram representative of example machine readable instructions which may be executed to implement the example prediction apparatus of FIG. 5 to predict audience composition for future media presentations.

FIG. 7 is a flow diagram representative of example machine readable instructions which may be executed to implement the example apparatus of FIG. 5 to solicit audience members.

FIG. 8 is a block diagram of an example processor platform capable of executing the instructions of FIGS. 6 and/or 7 to implement the apparatus of FIG. 5.

### DETAILED DESCRIPTION

While there are a number of known methods to measure past and/or present media exposure and/or consumptions, such measurements do not predict the audience composition of future media presentations. Examples disclosed herein provide methods to predict the composition of an audience of a future media presentation based on indications of intent from a subset of people (e.g., panelists) to be a member of the audience for such future media presentation. Examples disclosed herein also measure and/or collect audience member behaviors and/or feedback related to media exposure and/or consumption. In accordance with some disclosed examples, media providers can use such audience member behavior information and/or feedback to develop and/or improve media offerings and/or to improve the relevance of advertisements targeted to particular audience members. In some examples, audience members are offered monetary rewards and/or other incentives in return for their feedback on what media they intend to consume and when they intend to consume the media.

In some disclosed examples, audience composition for future media events are predicted days or weeks before the media is actually presented. In some examples, media providers and/or other entities use such predictions to dynamically adjust marketing strategies, ad campaign resource allocations, and/or production scheduling. In this manner, advertisers, broadcasters, and/or content creators can implement strategies to adjust and/or improve readership, viewership, and/or listenership of their media (e.g., advertisements and/or content) based on the predictions of the media that persons intend to access. Such an improvement may be with respect to any factor of interest such as, for example, audience size, audience demographic composition, ratings, etc.

Some disclosed example methods to predict future audience compositions involve obtaining indications of intent from first prospective audience members (e.g., panelist(s)) to access first media, determining a portion of the first audience members that actually accessed (e.g., consumed) the media, and predicting a characteristic of an audience for second media based on the portion of the first audience members.

Some disclosed example apparatus to predict an audience composition for a future media event includes an audience member interface to obtain indications of intent from first audience members to join an audience for first media, an analyzer to determine a portion of the first audience members that actually joined the audience for the first media, and a predictor to predict an audience composition of second media of second audience members based on the portion of the first audience members.

Some disclosed example methods to solicit audience members to access media involve obtaining a bid from a media provider to solicit media consuming time from an audience member, providing the bid to the audience member, obtaining an indication of an intent by the audience member to access the media for which the media provider has offered the bid, and informing the media provider of whether the audience member was actually exposed to the media presentation.

Some disclosed example apparatus to solicit audience members to access media include a communication interface to obtain a bid from a media provider to solicit time from an audience member, an audience member interface to provide the bid to the audience member and to obtain an indication of intent from the audience member to access a media presentation for which the media provider has offered the bid, and a verifier to confirm whether the audience member actually accessed the media presentation.

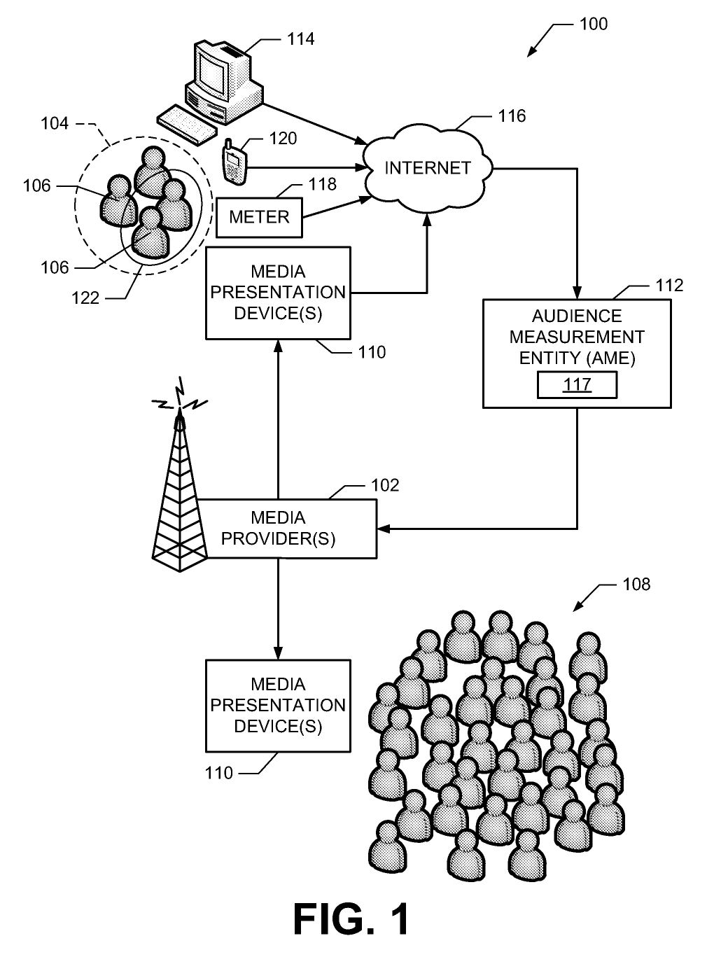

FIG. 1 is an example system 100 to predict an audience composition and/or to solicit audience members to join an audience of the media. The system 100 of FIG. 1 includes one or more media provider(s) 102 that provide media (e.g., television programming, on-demand media, Internet-based streamed media, advertisements, music, web pages, etc.) to a panel 104 of panel members 106. The panel members 106 of the illustrated example are a subset of a general audience population 108 that also receives the media from the media provider(s) 102. Both the panel 104 and the general audience population 108 of the illustrated example are exposed to media via any number and/or type(s) of media presentation devices 110 including televisions, computers, smart phones, tablets, radios, etc.

A person may enroll into the panel 104 to become a panel member 106 by consenting to participate in an audience measurement study conducted by an audience measurement entity (AME) 112 (e.g., the Nielsen Company or any other company, person (real or fictitious (e.g., a corporation)) or entity). In some examples, the media provider 102 may desire to establish its own panel 104 to track audience participation in the media it provides and/or to predict future audience participation. In such examples, the media provider 102 performs or implements techniques disclosed herein as being performed or implemented by the AME 112. Accordingly, in such examples, the media provider 102 provides content and performs the operations of an audience measurement entity (e.g., the AME 112) without needing to rely on or work with the AME 112 to implement examples disclosed herein.

In some examples, the enrollment of panel members 106 may be done via a computer, a telephone, a smart phone, a smart set-top box and/or any other suitable device. During enrollment, an account is set up to associate a panel member 106 with his/her indications of intent to access (e.g., consume) media and with his/her confirmations of actual media access (e.g., exposure and/or consumption). Other data (e.g., demographic data) associated with the panel members 106 is also collected during enrollment and/or at any time thereafter. Panelists are typically assigned an identifier and/or are provided with meters to log media exposure and/or identify persons (e.g., people meters).

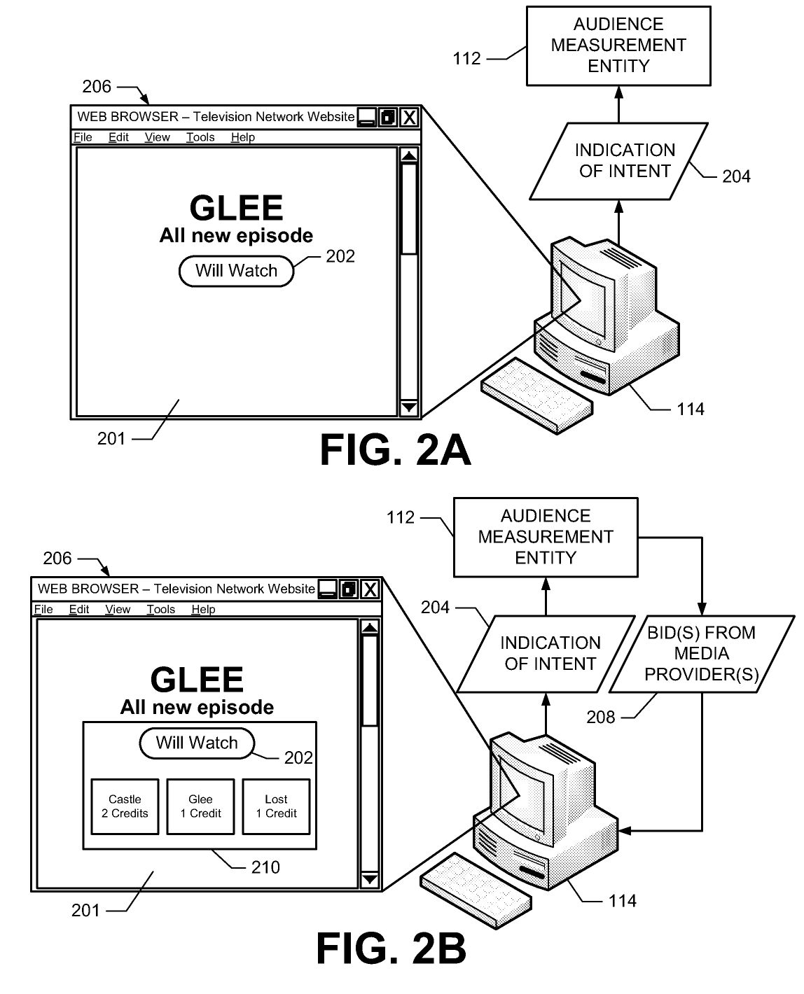

In some examples disclosed herein, predicting an audience composition is based on the expressed intent of the panel members 106 to access (e.g., consume) future media events. In examples disclosed herein, a person accesses media by tuning to a particular television channel or radio station broadcasting the media at a particular time. Additionally or alternatively, a person can access media by navigating to a website, requesting on-demand programming, and/or using any other Internet-based interface(s) to retrieve or receive media. An expressed intent to consume future media events is referred to herein as an indication of intent. Indications of intent are obtained from panel members 106 via intent indicators 114 and may be obtained anytime before the presenting of the future media (e.g., immediately before, 24 hours before, one week before, etc., the presenting of the media). Intent indicators 114 may be implemented using computers, telephones, cell phones, mobile devices, tablets, smart televisions, set-top boxes, and/or any other suitable device capable of receiving user input and transmitting the same via a network (e.g., the Internet 116, an intranet, the plain old telephone system (POTS), etc.). Example intent indicators 114 and methods for collecting indications of intent are described in detail below in connection with FIGS. 2A and 2B.

When an indication of intent is submitted by a panel member 106, the indication of intent is transmitted via the Internet 116 to the AME 112 where the information is stored and analyzed in connection with panel member data pertaining to the panel members 106. In the illustrated example, panel member data includes one or more of media-interest information, media-preference information, product-affinity information, demographics, viewing history, etc.

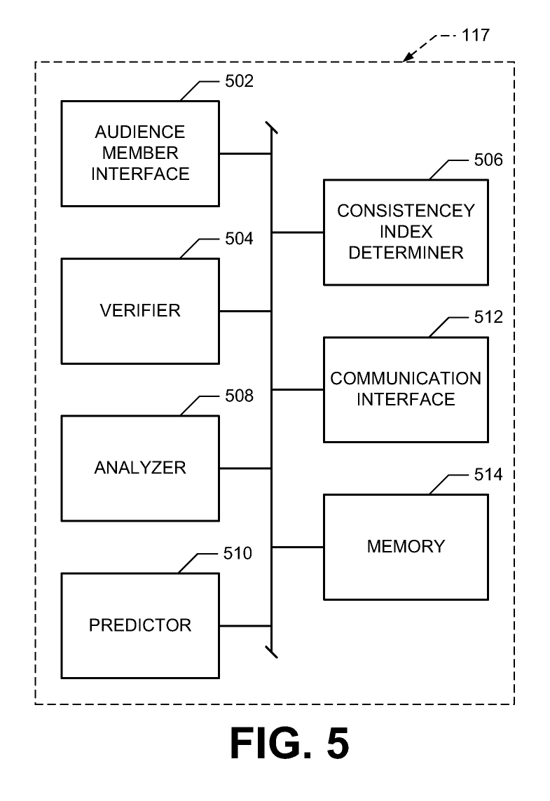

In the illustrated example, the AME 112 implements an example prediction apparatus 117 (discussed in greater detail below in connection with FIG. 5) to use the indications of intent and the panel member data to predict the audience composition of one or more future media and/or media events. In some examples, predicting audience composition of future media includes predicting demographic compositions of the audience, the size of the audience, consistency indices of audience members (described in greater detail below), and/or any other audience measurement information that is collected and associated with the panel members 106. For example, if a high quantity of panel members 106 having particular demographics (and/or associated with other particular panel member data of interest) provide indications of intent to join a particular audience (e.g., to access (e.g., consume) a particular media presentation), the AME 112 uses statistical methods to extrapolate that members of the general audience population 108, (e.g., also having the same demographics or associated with the same particular panel member data of interest) are also likely to be in the audience (e.g., of the particular media presentation). Examples disclosed herein make such inferences regarding the general audience population 108 based on reliabilities of the indications of intent. That is, examples disclosed herein treat an indication of intent as a probability that a corresponding panel member 106 will likely access (e.g., consume or at least be exposed to) a media presentation by joining an audience instead of an absolute assurance of such future behavior.

The reliability or unreliability of indications of intent may be based on any number of reasons. For example, a panel member 106 may forget to attend (e.g., consume) a media presentation or may run into time constraints precluding such attendance. Thus, while some indications of intent may be sincere, their fulfillment (or actual exposure) may not occur. In other instances, some panel members 106 may submit indications of intent without having actual commitment, for example, without any sincerity or actual intent to follow through. Examples disclosed herein predict audience composition based on indications of intent to consume with relatively high accuracy by collecting data indicating the historical consistency of the panel members 106 for actually accessing (e.g., actual exposure to and/or consumption of) media for which they submitted indications of intent. An indication of intent associated with a subsequent actual access by a panel member 106 (i.e., it is confirmed that the panel member 106 was actually exposed to media for which an indication of intent was provided) is referred to herein as a verified actual exposure. As used herein, media consumption refers to a person being at least partly attentive to a media presentation. As used herein, media exposure refers to a person's being near a media presentation irrespective of attentiveness.

In the illustrated example, to verify actual exposure, the AME 112 determines what media the panel members 106 actually accessed. For each accessed media presentation, the AME 112 generates a verified actual exposure corresponding to an indication of intent to consume previously submitted by the corresponding panel member 106.

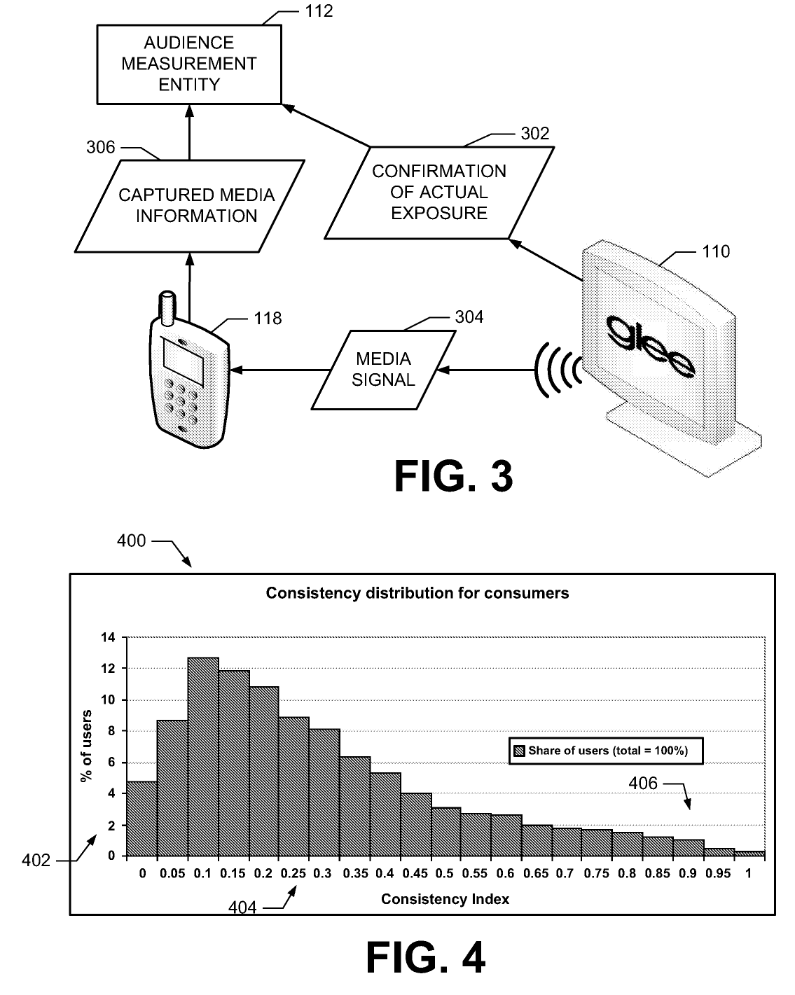

To determine what media an individual is accessing and/or has accessed, panelists are provided with one or more meters 118 (e.g., software, hardware, and/or firmware) to detect the identity of the media presented via the monitored media presentation devices 110, and to communicate such measurements to the AME 112 (e.g., via the Internet 116) to report whether and when the panelists have been exposed to the media presentations. In other examples, media exposure confirmation software, firmware, and/or hardware may be provided on a smart phone or other mobile device 120 to measure media exposure and then send such measurement information to the AME 112 (e.g., via the Internet 116 or a cellular phone network). For example, the mobile device 120 may be worn or carried by a panel member 106 and provided with any suitable detection/collection capabilities (e.g., audio, radio frequency, and/or light sensors) to collect identifying information (e.g., codes, watermarks, signatures, fingerprints, media samples, etc.) about media presented by the media presentation device(s) 110. In such examples, the AME 112 of the illustrated example uses such collected information to identify the media to which a corresponding panel member 106 was exposed. As the AME 112 receives data regarding the media to which a panel member 106 has actually been exposed, the AME 112 may then verify whether the media corresponds to previously received indications of intent. Example methods to verify actual exposures are described in greater detail below in connection with FIG. 3.

Reliable predictions of audience compositions of future media may be made by measuring the consistency with which the panel members 106 have followed through on their indications of intent in the past. For example, by comparing the number of verified actual exposures of each panel member 106 with the total number of indications of intent obtained from that panel member 106, the AME 112 can quantify how consistent each of the panel members 106 are at following through on their indications of intent. This ratio of verified actual exposures to total indications of intent calculated for each panel member 106 is referred to herein as a consistency index. In the illustrated example, the AME 112 uses a consistency index for each panel member 106 to form a prediction pool 122 based on a subset of the panel 104 that includes panel members 106 that have relatively high consistency indices (i.e., they usually access (e.g., consume or are exposed to) the media for which they provide indications of intent to consume). The determination of the prediction pool 122 is described in greater detail below in connection with FIG. 4.

While the quantity of panel members 106 that fall within the prediction pool 122 may be small relative to the panel 104, the prediction pool 122 of the illustrated example is sufficiently large to generate statistically robust predictions of the composition of an audience of the general population 108. To increase the size of the reliable prediction pool 122, the AME 112 may offer incentives (e.g., rewards) to the panel members 106 to provide indications of intent to consume media and/or to follow through on such indications by actually accessing the indicated media.

In some examples, rewards can be optionally implemented. For example, in some instances rewards may bias the prediction pool 122 and cause some loss of predictive power when applied or extrapolated to a larger population. In other words, panel members 106 that belong to the prediction pool 122 are more incentivized and their behavior may not extrapolate and/or generalize accurately over an entire population (who are less incentivized). As such, in some examples where the AME 112 desires relatively highly objective audience measurement data to extrapolate to a more general population (e.g., the general audience population 108 or the population at large) without any possible bias, the AME 112 may not provide incentives so as to avoid creating possible bias in the behavior of the panel members 106 that could otherwise be undesirably influenced. However, in other examples where the AME 112 is less concerned with bias, or where bias will have a lesser or no effect, the AME 112 may provide an incentive to encourage additional panel members 106 to consider the media provided by the media provider 102. Accordingly, the use of incentives in some examples is optional.

An example incentive structure rewards the panel members 106 for each verified actual exposure. The incentive structure may be fashioned similarly to a loyalty rewards program by crediting points to an account of each panel member 106 that can be subsequently redeemed for goods, services, and/or cash. Alternatively, the panel members 106 may be given cash or other rewards directly without any point system. Additionally or alternatively, any other incentive structure may be implemented to encourage the panel members 106 to follow through on their indications of intent. In some examples, the incentive rewards may come from the media providers 102 when their media are accessed by the panel members 106 that previously provided indications of intent to consume the media. Accordingly, as the AME 112 of the illustrated example verifies the actual exposure and/or consumption of media to generate predictions of the audience composition for future media, the AME 112 also communicates the verified actual exposures to the media provider 102.

Since ones of the panel members 106 in the prediction pool 122 will have reliable consistency indices, examples disclosed herein use the indications of intent associated with the prediction pool 122 as highly reliable predictors of actual exposure to future media (i.e., there is a high level of confidence that the indications of intent, as informed by the consistency indices, represent a subsequent actual exposure to the indicated media) by members of the prediction pool 122. As such, examples disclosed herein use the prediction pool 122 to accurately predict the audience composition of a more general population, such as the general audience population 108 by extrapolating data collected from the prediction pool 122 to the more general population via statistical methods. In some examples, the prediction pool 122 includes all of the panel members 106 where the consistency indices of each panel member is weighted according to the reliability of the consistency indices (e.g., panel members 106 with relatively high consistency indices will be given more weight).

The AME 112 of the illustrated example updates consistency indices when actual exposure is checked. That is, after media has been presented, the consistency index for each panel member 106 (whether a member of the prediction pool 122 or not) that provided an indication of intent to consume the corresponding media is updated based on whether or not the corresponding panel member 106 was actually exposed to (e.g., accessed) the media. In this way, the AME 112 can improve the accuracies of its audience composition predictions over time by dynamically updating consistency indices as additional media presentations occur. In addition, by dynamically updating consistency indices, the AME 112 can track how the consistency index for each panel member 106 changes over time due to changing media habits and/or any other factor(s). For example, there may be a period of time during which a panel member 106 provides many indications of intent but follows through on relatively few of them (e.g., relatively few are verified), resulting in a relatively low consistency index for that period of time. In contrast, the same panel member 106 at a different period of time may be more selective in providing indications of intent to consume media (e.g., relatively fewer indications of intent) but almost always follows through in accessing the indicated media, resulting in a relatively higher consistency index for that period of time. As a result, the panel members 106 that the AME 112 selects to form the prediction pool 122 in the illustrated example may vary at any given moment in accordance with the most recent consistency indices for each of the panel members 106. Accordingly, in some examples, the panel members 106 that form the prediction pool 122 will not necessarily know whether their media exposures contribute to predictions.

In some examples, to keep the consistency index of each panel member 106 accurate and representative of the panelist's most recent habits of accessing media, the consistency indices are determined/updated based on demarcated periods of time (e.g., the most recent three months). In some examples, running averages are determined for the consistency indices of the panel members 106. In other examples, consistency indices are calculated and/or updated differently in different situations. For example, a weighting factor may be used to assign more weight to panel members 106 that access media during the regular broadcast schedule times instead of recording the media (e.g., on a digital video recorder (DVR)). In some examples, exposure to recorded media may be less favorable because advertisements are more likely to be skipped while watching the previously recorded media. In some examples, weighting factors corresponding to one or more other media and/or audience characteristics (e.g., format of the media, demographics, etc.) may additionally or alternatively be used to weight consistency indices. In some examples, such weighting factors may be used to selectively admit members into the prediction pool 122 from different groups to customize predictions based on different audience member and/or media characteristics. In this way, the prediction pool 122 may be dynamically adjusted and/or refined to vary the composition of the collected data based on its intended use. Once the prediction pool 122 is identified and a prediction of the number of audience members that will access the relevant media has been determined, the AME 112 of the illustrated example communicates the predictions to its clients (e.g., media providers 102, advertisers, manufacturers, and/or other entities that have paid for the information). In the illustrated example, the media providers 102, advertisers, manufacturers, and/or other entities use the prediction information to assess the anticipated audience exposure for the corresponding media and to identify opportunities to buy/sell advertising space based on such predicted audience exposure.

Examples disclosed herein also involve soliciting panel members 106 and/or members of the general audience population 108 to join an audience for media. In some examples, the solicitations may be offered to panel members 106. In other examples, the solicitations may be offered to people more generally (e.g., members of the general audience population 108 perhaps in addition to the panel members 106). If people desire to respond to the solicitations and are not already panel members 106, they may be requested to enroll as panel members 106. Accordingly, examples disclosed herein refer to panel members 106 but it should be understood that some examples may apply equally to people more generally (e.g., members of the general audience population 108) prior to becoming panel members 106 (i.e., prospective panel members).

As described above, media providers 102 may offer rewards for the time and attention of panel members 106. However, multiple media providers 102 desire the time and attention of audience members during the same timeslots because audience members usually access only one media presentation (e.g., watch only one television program or listen to only one radio program) during any particular timeslot. As such, examples disclosed herein allow the media providers 102 to compete in a market-like setting for audience member viewership or listenership during desired timeslots. In some examples, the media providers 102 provide bids offering cash, redeemable points, or other types of rewards to panel members 106 that have accessed the media for which they provided indications of intent to consume. In the illustrated examples, a media provider 102 uses a bid to encourage panel members 106 to commit early to consuming a particular media presentation of the bidding media provider 102 or to convince the panel members 106 to change their indications of intent from media of a competitor scheduled during the same timeslot. If the panel members 106 are persuaded by the value of the bid associated with the identified media, the panel members 106 accept the bid by providing an indication of intent to consume the media. After the actual exposure of the media by the panel members 106 has been verified, the verified actual exposure is communicated to the media provider 102. The media provider 102 then credits the panel members 106 with the offered reward.

Media providers 102 of the illustrated example use bids to build loyal audiences by rewarding panel members 106 for their media exposure time, thus enabling media providers 102 to expose the panel members 106 to additional programming (e.g., other television programs, radio programs, advertisements, etc.). At the same time, panel members 106 are benefited by encouraging the development of media that they are interested in and by being compensated for the media they actually access.

In some examples, the media providers 102 provide bids to panel members 106 via a common bid repository of a communication interface (e.g., on the same Internet website). As a result, the competing offers from the different media providers 102 can be reviewed and compared by panel members 106 before submitting an indication of intent for an identified media presentation. Additionally or alternatively, when a panel member 106 seeks to provide indications of intent to consume media during a particular timeslot, bids from other media providers 102 for the same particular timeslot can be presented (e.g., in real time) to the panel member 106. In some examples, competitor bids are provided to media providers 102. In this manner, the media providers 102 may view and/or compare the bids of other media providers 102 to determine whether to adjust their own bids to potentially draw away panel members 106 from the other media providers 102. Additionally or alternatively, the media providers 102 of the illustrated example are provided access to the indications of intent of panel members 106 toward competitor media providers. In some examples, the media providers 102 use this information to determine whether to adjust their bids and/or media programming strategies to attract a larger audience by outbidding or outperforming competing media providers 102. In this manner, the media providers 102 may solicit the panel members 106 to change their indications of intent based on bidding matches and/or based on adjusted promotions of media by the media providers 102.

In some examples, the AME 112 shares specific information regarding each panel member 106 (e.g., demographics, viewing history, media-interest information, media-preference information, product affinity information, consistency index, etc.) with the media providers 102 to facilitate targeting bids to particular panel members 106 based on such panel member data. In some examples, the targeting is determined based on which panel members 106 (e.g., based on the audience member information) are more likely to accept particular bids and follow through after submitting indications of intent to consume identified media. In some examples, this involves obtaining consent from the particular panel members 106 before directly targeting them. In some examples, the actual identification of the panelists and/or their contact information is withheld from the media providers 102.

FIGS. 2A and 2B illustrate example manners of implementing the example intent indicator 114 of FIG. 1. Although the intent indicator 114 is shown as a computer in FIGS. 1, 2A, and 2B, the intent indicator 114 may be a computer, a smart phone, a tablet, a connected television, a smart set-top box, etc. In addition, although the intent indicator 114 is shown separate from the media presentation device 110 in FIG. 1, the intent indicator 114 may be implemented in the media presentation device 110 (e.g., as a software application). In the illustrated example, the intent indicator 114 provides a user interface 201 having an intent button 202 (e.g., the “Will Watch” button in FIGS. 2A, 2B) located thereon. In the illustrated example, the user interface 201 provides the panel members 106 (FIG. 1) with access to media programming schedules of the different media providers 102 and/or to sites of media programs presented via the media presentation devices 110. While viewing the user interface 201, a panel member 106 submits an indication of intent 204 over, for example, the Internet 116 (FIG. 1), by clicking the intent button 202. In the illustrated example, the user interface 201 is a website that is associated with a particular media program and/or the AME 112. For example, a panel member 106 of the illustrated example visits the website using a web browser 206 on the intent indicator 114 and navigates to a webpage about an upcoming episode of a television show (e.g., “Glee”). If the panel member 106 is interested in consuming the described episode of the television show, the panel member 106 clicks on the intent button 202 to submit an indication of intent 204 to consume the episode. In the illustrated example, the intent indicator 114 submits the indication of intent 204 via the Internet 116 to the AME 112 and/or the media providers 102.

As shown in FIG. 2B, in some examples, the AME 112 provides bid(s) 208 from one or more of the media providers 102 to the panel member 106 in response to the AME 112 receiving the indication of intent. In the illustrated example, after the panel member 106 clicks on the intent button 202 and the intent indicator 114 receives the bid(s) 208, a bid context window 210 is displayed. The bid context window 210 shows the bid value (e.g., points rewarded) for the selected episode of “Glee” as well as the bid value(s) (e.g., shown as credits in FIG. 2B) from competing media providers 102 soliciting the panel member 106 to access and/or consume competing media offered during the same timeslot as the selected episode of “Glee.” (The bids may be from different media providers 102 and/or two or more of the bids may be associated with the same media provider 102). The panel members 106 may decide to keep the indication of intent to watch “Glee” or may be persuaded to change their indications of intent to watch different media identified in one of the bids that has an appealing reward associated with it. While the context window 210 may be embedded in the same user interface 201 (e.g., the same webpage) as the intent button 202, as shown in FIG. 2B, in other examples the click on the intent button 202 may direct the panel members 106 to a new webpage where the competing bids 208 are displayed for comparison by the panel members 106. In some examples, the intent indicator 114 may instantiate (e.g., open, spawn, etc.) a separate user interface (e.g., a new webpage) when the intent button 202 is clicked to prompt the panel members 106 to sign into a respective account if the intent indicator device 114 does not already otherwise recognize the panel members 106 (e.g., via a cookie or a previous login session).

Although the bid(s) 208 are described above as being communicated to the intent indicator 114 after the panel member 106 has clicked on the intent button 202 and the intent indicator 114 has sent the indication of intent to the AME 112, in other examples the AME 112 sends the bid(s) 208 to the intent indicator 114 before the panel member 106 submits an indication of intent. In such examples, when the panel member 106 browses information on the user interface 201 (e.g., a webpage) for a particular media event, the intent indicator 114 presents the bid(s) 208 (e.g., in the bid context window 210 or a separate window) to allow the panel member 106 to compare competing bid(s) 208 before deciding on a particular media event for which to submit an indication of intent.

In addition to or instead of websites dedicated to respective media events as described above, intent buttons 202 may be embedded in any other website associated with media and media information (e.g., a TV GUIDE program schedule, a YAHOO! TV Listings program schedule, etc.). Similarly, intent buttons 202 may be incorporated into social networking websites (e.g., FACEBOOK websites, TWITTER websites, etc.) to enable panel members 106 to provide indications of intent if they, for example, learn through friends on FACEBOOK about media that they want to consume. Alternatively, indications of intent may be provided via an electronic program guide presented through a DVR device, a set-top box (STB), a satellite receiver, etc.

In some examples, the intent indicator 114 is implemented in mobile devices (e.g., smart phones, tablet devices, etc.) synchronized with real time media events via media detection/recognition software (e.g., Media-Sync applications developed jointly by The Nielsen Company and Digimarc Corporation). In this manner, a mobile intent indicator 114 worn or carried by a panel member 106 may recognize media being currently accessed by the panel member 106 and present the intent button 202 relating to future timeslot(s) airing future media (e.g., future episodes) associated with the media that is presently recognized by the media detection/recognition software and/or with different media (e.g., upcoming in a next timeslot, etc.).

FIG. 3 illustrates example methods of verifying actual exposure to media to confirm when the panel members 106 have followed through on their indications of intent by actually accessing corresponding media. In the illustrated example, verifying actual exposure involves (a) confirming that media was actually accessed and (b) determining whether the accessed media corresponds to an indication of intent previously obtained from a corresponding panel member 106.

In some examples, existing Nielsen meters to collect audience measurement data are used to identify the audience members and the media to which they are exposed. In such examples, dedicated meters are positioned in panelist sites (e.g., homes) to collect codes, signatures, and/or tuning data representative of media presented via the monitored presentation devices 110 and people meter are positioned in the panelist sites to identify audience members.

In some examples, the media presentation devices 110 are provided with a meter (e.g., metering software) to identify media presented by the media presentation devices 110. In such examples, the metering software executes on the media presentation devices 110 and communicates with the AME 112 via the Internet 116 to report confirmation of actual exposures 302 indicative of verified actual exposures to media. In such examples, the metering software or the media presentation devices 110 also collects and send users identification data (e.g., people meter data) to associate the verified actual exposures with the corresponding panel members 106.

In some examples, exposures to media are verified using mobile devices 120 worn or carried by the panel members 106. In this manner, exposures can be verified when metering software is not installed on the media presentation devices 110 and/or when panel members 106 access media presentations on other media presentation devices 110 (e.g., media accessed away from home). In such examples, a smart phone or other mobile device 120 with media detection/recognition software installed on it is worn or carried by panel members 106 and is used to confirm exposure to media by the panel members 106. In particular, panel members 106 may download a media exposure confirmation application that includes media detection/recognition software and install it on a mobile device 120. For example, the application may be downloaded and installed during the initial enrollment of the panel members 106 or at anytime thereafter. When the panel members 106 are exposed to media corresponding to an indication of intent that the panel member 106 previously provided, the panel member 106 may activate the exposure confirmation application. Alternatively, the media detection/recognition program may run at appropriate times (e.g., periodically, aperiodically, continuously) in the background collecting and/or analyzing audio and/or video samples.

Through a microphone, camera, or other suitable sensor on the mobile device 120, the media detection/recognition software of the illustrated example records a media signal 304 (e.g., an audio or video signal) from the media presentation device 110 and collects signatures, codes and/or watermarks (e.g., captured media information 306) from the media. Codes and watermarks are implemented when the media signal 304 is included with and/or embedded in the media being monitored. In contrast, media detection/recognition based on signatures implements one or more inherent characteristics of the monitored media during a monitoring time interval to generate a substantially unique proxy for the media (referred to as a signature) that takes the form of a series of digital values, a waveform, etc., representative of the media signal 304 of the media being presented.

The mobile device 120 transmits the captured media information 306 to the AME 112 via the Internet 116. The mobile device 120 of the illustrated example also transmits a user identification and/or tag of the panel member 106 to identify the particular panel member 106 accessing the media. In the illustrated example, the AME 112 compares the captured media information 306 with reference media information in a database to identify matching media thereby identifying what media was actually accessed by the panel member 106.

When the media has been identified and confirmed as actually accessed, the AME 112 of the illustrated example compares the identified media to the previously collected indications of intent obtained from the corresponding panel member 106. If the AME 112 determines that an indication of intent was received from the panel member 106 for the identified media, the AME 112 verifies the actual exposure to the media and updates the consistency index of the corresponding panel member 106. If the AME 112 determines that an indication of intent was not obtained from the corresponding panel member 106 for the identified media, then there is no media to verify for actual exposure and the exposure of the media to the particular panel member 106 does not affect the consistency index of the particular panel member 106.

FIG. 4 is an example distribution graph 400 illustrating how media exposure consistency indices may vary for the example panel 104 of FIG. 1. The example distribution graph 400 of consistency indices of FIG. 4 shows that the panel members 106 follow through on their indications of intent with different degrees of consistency. In the illustrated example, the Y-axis 402 of the distribution graph 400 corresponds to percentages of panel members 106 of the panel 104 and the X-axis 404 corresponds to the consistency indices of the panel members 106. In some examples, the AME 112 uses the distribution graph 400 to select ones of the panel members 106 to be in the prediction pool 122 based on those panel members 106 that fall within a tail portion 406 of the distribution at which the consistency indices are relatively high (e.g., exceed a value of 0.9). In the illustrated example of FIG. 4, the quantity of panel members 106 with consistency indices high enough to be included in the prediction pool 122 is based on the corresponding percentages of users measured on the Y-axis 402 for panel members 106 having consistency indices greater than 0.9 as measured by the X-axis 404. To increase the consistency indices and, thus, the size of the prediction pool 122 the AME 112 may use an incentive structure to encourage panel members 106 to follow through on their indications of intent.

FIG. 5 shows an example implementation of the example prediction apparatus 117 of FIG. 1 which is to predict the composition of an audience for future media and/or solicit audience members to join an audience. In some examples, the apparatus 117 is implemented by the AME 112 as shown and described above in connection with FIG. 1. In the illustrated example of FIG. 5, the example apparatus 117 includes an example audience member interface 502, an example verifier 504, an example consistency index determiner 506, an example analyzer 508, an example predictor 510, an example communication interface 512, and an example memory 514.

While an example manner of implementing the prediction apparatus 117 of FIG. 5 has been illustrated in FIG. 5, one or more of the elements, processes and/or devices illustrated in FIG. 5 may be combined, divided, re-arranged, omitted, eliminated and/or implemented in any other way. Further, the example audience member interface 502, the example verifier 504, the example consistency index determiner 506, the example analyzer 508, the example predictor 510, the example communication interface 512, the example memory 514, and/or, more generally, the example apparatus 117 of FIG. 5 may be implemented by hardware, software, firmware and/or any combination of hardware, software and/or firmware. Thus, for example, any of the example audience member interface 502, the example verifier 504, the example consistency index determiner 506, the example analyzer 508, the example predictor 510, the example communication interface 512, the example memory 514, and/or, more generally, the example apparatus 117 of FIG. 5 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example audience member interface 502, the example verifier 504, the example consistency index determiner 506, the example analyzer 508, the example predictor 510, the example communication interface 512, and/or the example memory 514, are hereby expressly defined to include a tangible computer readable medium such as a memory, DVD, CD, BluRay, etc. storing the software and/or firmware. Further still, the example apparatus 117 of FIG. 5 may include one or more elements, processes and/or devices in addition to, or instead of, those illustrated in FIG. 5, and/or may include more than one of any or all of the illustrated elements, processes and devices.

Turning in detail to FIG. 5, the example prediction apparatus 117 is provided with the audience member interface 502 of the illustrated example to send information to panel members 106 regarding future media and to receive from the panel members 106 their indications of intent to consume the future media. In some examples, the audience member interface 502 is a web server to serve web pages for display in a web browser of an intent indicator 114. The audience member interface 502 of the illustrated example also causes the intent button 202 (FIGS. 2A, 2B) to be displayed. In the illustrated example, panel members 106 click on the intent button 202 to submit their indications of intent, which are sent via the Internet 116 to the AME 112 for collection and analysis. In some examples, the audience member interface 502 also sends panel members 106 bids from media providers 102 soliciting members of the panel 104 to join an audience for particular media.

To verify when a particular media presentation corresponding to an indication of intent was actually accessed, the apparatus 117 of the illustrated example is provided with the verifier 504. In the illustrated examples, the verifier 504 receives confirmations of actual exposures 302 via metering software loaded on media presentation devices 110 that report to the AME 112 what media have been accessed and who accessed the media. Additionally or alternatively, the example verifier 504 receives captured media information 306 from mobile devices 120 worn or carried by panel members 106. In such examples, the mobile devices 120 have media detection/recognition software to identify the media that is accessed and associate it with the corresponding panel member 106 that accessed the media. Once media actually accessed by each panel member 106 has been identified, the verifier 504 of the illustrated example verifies whether the accessed media correspond with indications of intent previously received via the audience member interface 502 from the corresponding panel members 106 that accessed the identified media.

In the illustrated example, the prediction apparatus 117 is provided with the consistency index determiner 506 to determine or calculate the consistency index for each panel member 106 based on the ratio of the total number of indications of intent obtained via the audience member interface 502 and the total number of verified actual exposures determined via the verifier 504. In some examples, the consistency index may be calculated based on the total verified actual exposures and the total indications of intent over a demarcated period of time (e.g., the most recent three months). In some examples, the consistency index determiner 506 applies a weighting factor to adjust the weight of the consistency indices based on one or more media and/or audience characteristics.

In the illustrated example, the apparatus 117 is provided with the analyzer 508 to analyze the collected data to determine the prediction pool 122 from which the predictor 510 predicts the audience composition for future media. In some examples, the analyzer 508 determines the prediction pool 122 by reviewing the consistency indices of every panel member 106 to isolate the panel members 106 having consistency indices above a certain threshold (e.g., greater than 0.9). In other examples, the analyzer 508 determines the prediction pool 122 by including all panel members 106 and by assigning greater weight to the panelists with higher consistency indices. In yet other examples, the analyzer 508 may determine the prediction pool 122 based on one or more media and/or audience characteristics.

The predictor 510 of the example apparatus 117 uses the data corresponding to the panel members 106 of the prediction pool 122 to predict the audience composition for future media of a more general audience (e.g., the general audience population 108).

To provide the media providers 102 and/or other entities with the predictions of audience composition for future media and/or verified actual exposures to media, the example prediction apparatus 117 is provided with a communication interface 512. In some examples, the communication interface 512 enables a media provider 102 and/or other entities to review the predictions of future media audience composition(s) to determine the anticipated success of the media and/or to determine pricing for broadcast and/or other media. In some examples, the communication interface 512 enables the media providers 102 to provide bids soliciting audience members to access particular media presentations and to see when panel members 106 have responded by submitting indications of intent. Additionally, the communication interface 512 in the illustrated example provides the media providers 102 with the bids of competing media providers to allow the media providers 102 to determine whether to adjust their own bids and/or media programming strategies. Additionally or alternatively, the communication interface 512 of the example apparatus 117 provides the media providers 102 with the indications of intent submitted by panel members 106 to join the audience for future media of competing media providers. In this manner, the media providers 102 can review the indications of intent to determine whether to adjust their own bids and/or media programming strategies. In some examples, the media providers 102 may also review panel member data (e.g., demographics data) via the communication interface 512 to identify panel members 106 to target with particular bids to solicit audience members from the identified panel members 106.

Furthermore, in the illustrated example, the communication interface 512 enables the media providers 102 to be notified when their media have actually been exposed to panel members 106 who previously submitted an indication of intent. The media providers 102 can use this information to reward the identified panel members 106 for accessing the media for which an indication of intent was previously received. In the illustrated example, such rewards may be based on an incentive structure to increase the prediction pool 122 within the panel 104. Additionally or alternatively, the rewards provided by the media providers 102 may be based on bids offered by the media providers 102 to solicit audience members from panel members 106 of the panel 104.

In the illustrated examples, the memory 514 stores data associated with each of the panel members 106 including their profile information, their indications of intent, their verified actual exposures, and their consistency indices. Additionally or alternatively, the memory 514 of the illustrated example may store reference media information to match with the captured media information 306 from the mobile devices 120 to identify what media have been accessed. In some examples, the memory 514 stores the bids from the media providers 102 soliciting audience members to access media

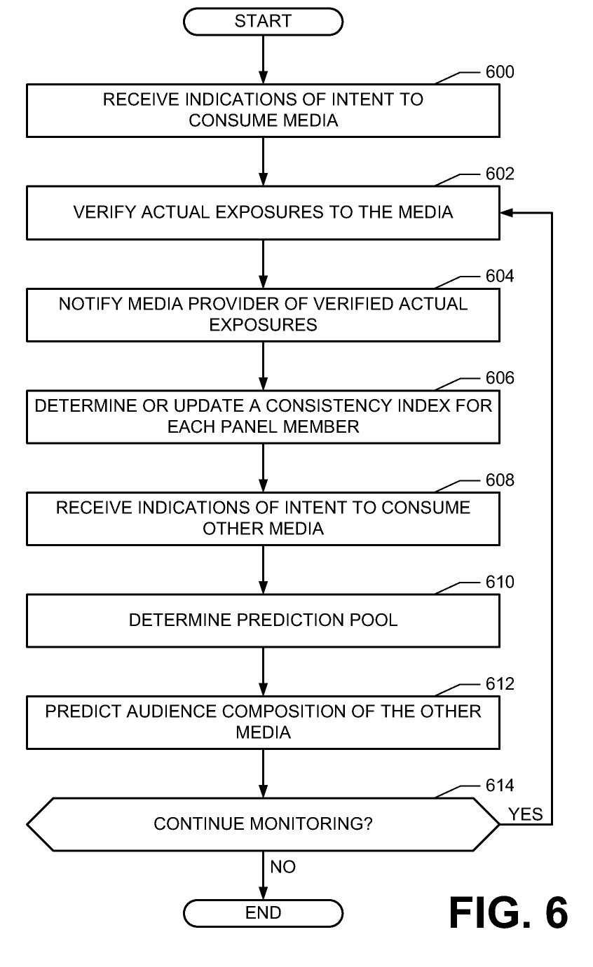

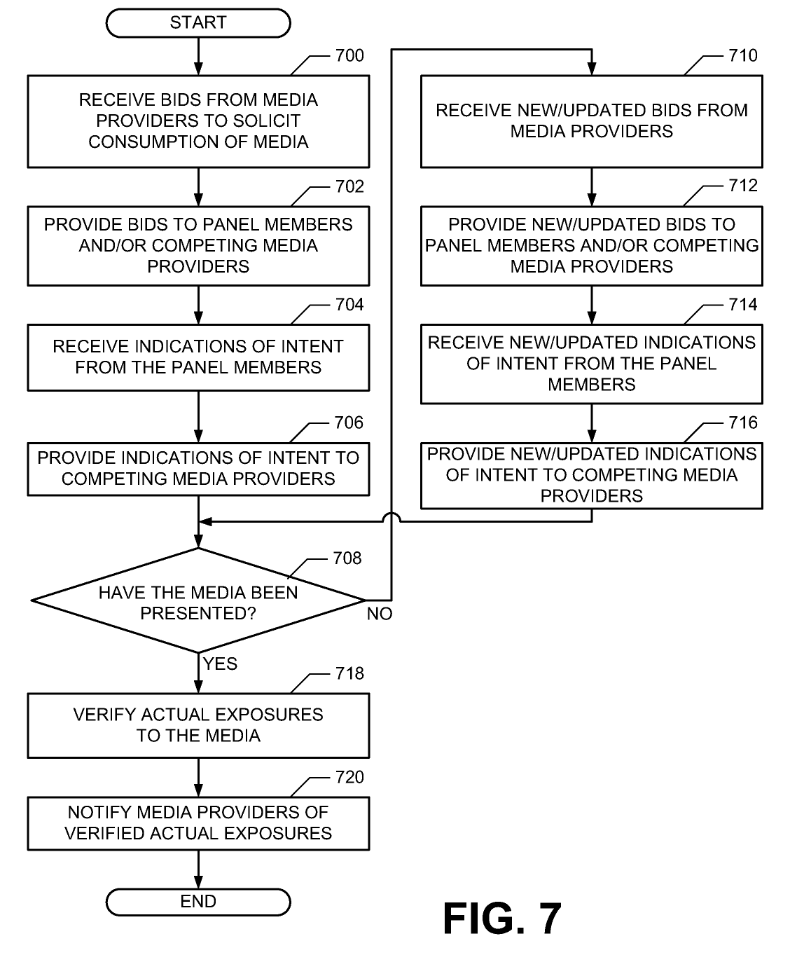

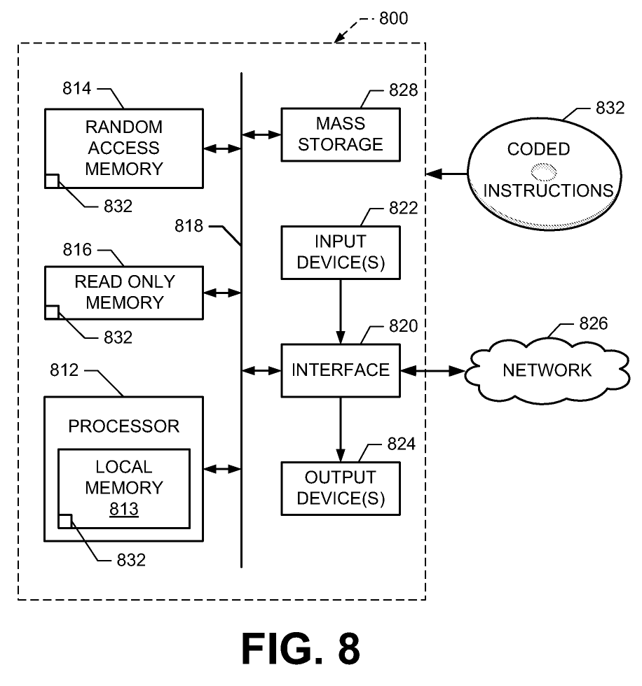

Flowcharts representative of example machine readable instructions for implementing the apparatus 117 of FIGS. 1 and/or 5 are shown in FIGS. 6 and 7. In these examples, the machine readable instructions comprise a program for execution by a processor such as the processor 812 shown in the example processor platform 800 discussed below in connection with FIG. 8. The program may be embodied in software stored on a tangible computer readable medium such as a CD-ROM, a floppy disk, a hard drive, a digital versatile disk (DVD), a BluRay disk, or a memory associated with the processor 812, but the entire program and/or parts thereof could alternatively be executed by a device other than the processor 812 and/or embodied in firmware or dedicated hardware. Further, although the example program is described with reference to the flowcharts illustrated in FIGS. 6 and 7, many other methods of implementing the example apparatus 117 may alternatively be used. For example, the order of execution of the blocks may be changed, and/or some of the blocks described may be changed, eliminated, or combined.

As mentioned above, the example processes of FIGS. 6 and 7 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6 and 7 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The example flowchart of FIG. 6 is representative of an example program to predict audience composition for future media. Initially, the audience member interface 502 (FIG. 5) receives indications of intent 204 (FIG. 2A) to consume media from panel members 106 (block 600). For example, each panel member 106 may click on the intent button 202 (FIG. 2A) on a webpage associated with the media and/or the AME 112 on the intent indicator 114 (FIGS. 1 and 2A). The intent indicator 114 sends the indications of intent 204 to the AME 112 and/or the media providers 102 via the Internet 116, and the apparatus 117 stores the indications of intent 204 in the memory 514 for subsequent use and analysis.

After the media has been presented, the verifier 502 (FIG. 5) verifies whether the panel members 106 were actually exposed to the media (block 602). For example, the verifier 502 can verify the actual exposure by determining whether the accessed media is associated with indications of intent previously received from the panel members 106. In some examples, confirmation of actual exposure is performed using metering software installed on media presentation devices 110 presenting the media. In some examples, confirmation of actual exposure is performed using mobile devices 120 worn or carried by panel members 106 and having media detection/recognition software that detects the media and sends collected media information (e.g., the captured media information 306 of FIG. 3) to the AME 112 along with data identifying the corresponding panel members 106. In the illustrated example, the AME 112 analyzes the captured media information to identify the media that was actually accessed and associates it with the corresponding panel members 106. Once identified, the verifier 502 of the illustrated examples verifies the actual exposure by determining whether the media actually accessed corresponds to an indication of intent to consume the media previously submitted by the corresponding panel members 106.

In the example program of FIG. 6, the communication interface 512 (FIG. 5) notifies a media provider 102 associated with the accessed media of the verified actual exposure of the media presentation to the panel members 106 (block 604). In some examples, the media provider 102 rewards the panel members 106 that were actually exposed to the media for which they submitted an indication of intent to consume.

In the illustrated example, the consistency index determiner 506 (FIG. 5) determines and/or updates a consistency index for each panel member 106 (block 606). In some examples, the consistency index is determined as the ratio of the total number of verified actual exposures to the total number of indications of intent for each panel member 106. In some examples, the consistency index determiner 506 incorporates other factors (e.g., audience member and/or media characteristics) to adjust the weight of each consistency index and/or to limit the period of time over which the verified actual exposures and indications of intent will be counted.

The audience member interface 502 receives indications of intent to consume other media from panel members 106 (block 608). The process of receiving indications of intent at block 608 is the same as at block 600 except that the indications of intent are received for different media events scheduled to be presented after the presenting of the initial media.

The analyzer 508 determines the prediction pool 122 of FIG. 1 (block 610). For example, the analyzer 508 (FIG. 5) analyzes the consistency indices and indications of intent for each panel member 106 received at block 608 to determine the prediction pool 122. In some examples, the analyzer 508 selects the panel members 104 that have a relatively high consistency index (e.g., greater than 0.9) to form the prediction pool 122. In some examples, the analyzer 508 may include all panel members 106 in the prediction pool 122 and assign greater weight to the higher consistency indices. In other examples, the analyzer 508 may formulate a more focused prediction pool 122 based on one or more audience and/or media characteristics.

The predictor then predicts the audience composition of the other media (block 612) based on the indications of intent received from the panel members 106 within the prediction pool 122. In some examples, some of the panel members 106 of the prediction pool 122 will have provided indications of intent to consume the other media for which a prediction is desired. Based on the number of indications of intent received from the prediction pool 122, the predictor 510 (FIG. 5) of the illustrated example may predict the audience composition for the media by the prediction pool 122 with a relatively high probability because of the high consistency indices of the panel members 106 within the prediction pool 122. In some examples, the predictor 510 uses the indications of intent submitted by the prediction pool 122 to predict audience composition for the media by a larger audience (e.g., the general audience population 108).

After the other media have been presented, the prediction apparatus 117 determines whether it should continue to monitor indications of intent and actual exposures (block 614). If so, control returns to block 602 to verify whether the other media were actually accessed. In this manner, the consistency indices of the panel members 106 in the illustrated example are updated and become more reliable with each iteration of the process. After only the first iteration of the program of FIG. 6 the consistency index of each panel member 106 will have relatively less predictive value because the consistency index for each panel member 106 will be either zero or one. Each panel member 106 will have provided only one indication of intent that was either verified (e.g., the panel members 106 were actually exposed to the media) resulting in a consistency index of one, or not verified (e.g., the panel members 106 were not exposed to the media) resulting in a consistency index of zero. However, after each subsequent iteration of the example process of FIG. 6, the consistency index for each panel member 106 is updated and becomes more meaningful. Thus, over time the data increases in meaning, fullness, and reliability so that relatively more robust predictions of audience composition for future media may be made with higher levels of accuracy. If the apparatus 117 is not to continue monitoring (block 614), the example process of FIG. 6 ends.

Turning now to FIG. 7, the example program depicted may be used to solicit audience members to join an audience for future media. Initially, the communication interface 512 (FIG. 5) receives one or more bids from one or more of the media providers 102 to solicit audience members for particular media (block 700). In the illustrated example, the bids are then stored in the memory 514 (FIG. 5). At block 702, the audience member interface 502 (FIG. 5) provides the bid(s) 208 (FIG. 2B) to the panel members 106 (e.g., via the context window 210 of FIG. 2B). In this manner, the panel members 106 can compare the rewards offered in each bid and consider which of the corresponding media and bids are of sufficient interest to submit a corresponding indication of intent to consume (e.g., the indication of intent 204 of FIG. 2). As above, in some examples, the audience member interface 502 provides the bid(s) 208 to people more generally for their consideration and comparison. In this manner, people may determine whether they want to enroll as panel members 106 to receive the offered rewards associated with the provided bid(s) 208.

Additionally, in some examples, where there are multiple media providers 102 soliciting audience members to join audiences for particular media, the AME 112 may provide the bids 208 of each media provider 102 to the competing media providers 102 via the communication interface 512. As a result, the media providers 102 can compare the bids of competing media providers 102 to determine whether to adjust their bids and/or media programming strategy.

The audience member interface 502 (FIG. 5) receives indications of intent 204 (FIG. 2B) from one or more panel members 106 (block 704). For example, the panel members 106 that decide to access the media for which the bids 208 are provided will submit an indication of intent 204 via the audience member interface 502 to be stored in the memory 514. In some examples, when panel members 106 first attempt to provide an indication of intent to consume particular media (e.g., by clicking the intent button 202 (FIG. 2B) on a webpage associated with the particular media), the audience member interface 502 displays alternative bids 208 (e.g., in the context window 210) from competing media providers 102. In other examples, the competing bids 208 are provided prior to the panel members 106 providing any indications of intent. In some examples, the communication interface 512 provides the indications of intent 204 from the panel members 106 to the media providers 102 (block 706) so that the media providers 102 can determine whether to adjust their bids and/or media programming strategy.

The verifier 504 determines whether the media have been presented (block 708), thus enabling the opportunity for verification of actual exposures. If the media have not been presented (block 708), the communication interface 512 may receive new and/or updated bids 208 from the media providers 102 (block 710) that seek to offer different rewards to the panel members 106 to attract a larger audience. The audience member interface 502 provides the new and/or updated bids 208 to the panel members 106 and/or competing media providers 102 as described above (block 712). The audience member interface 502 receives any additional indications of intent 204 and/or any updates to previously submitted indications of intent 204 provided by the panel members 106 in response to the new and/or updated bids 204 (block 714). In some examples, the communication interface 512 may provide the new and/or updated indications of intent 204 to the competing media providers 102 (block 716) to determine whether they desire to make further adjustments to their bidding strategy.

The process then returns to block 708 where the verifier 504 determines whether the media have been presented. If the media have not been presented then control returns again to block 710, 712, 714, and 716 to allow media providers 102 to offer new and/or updated bids to panel members 106. When the media have been presented (block 708), control advances to block 718 where the verifier 504 confirms whether the panel members 106 were actually exposed to the media (block 718). In the illustrated example, the verifier 504 verifies the actual exposure by determining whether the media accessed are associated with indications of intent 204 previously received from the panel members 106 as described above.

The communication interface 512 sends notification of the verified actual exposures of the panel members 106 to the media providers 102 (block 720). In the illustrated example, the media providers 102 may reward the corresponding panel members 106 according to the bids 208 offered to the panel members 106. Once the media providers 102 are notified of the verified actual exposures to the media, the example program of FIG. 7 ends.

FIG. 8 is a block diagram of an example processor platform 800 capable of executing the instructions of FIGS. 6 and 7 to implement the apparatus of FIG. 5. The processor platform 800 can be, for example, a server, a personal computer, an Internet appliance, or any other type of computing device.

The process platform 800 of the instant example includes a processor 812. For example, the processor 812 can be implemented by one or more microprocessors or controllers from any desired family or manufacturer.

The processor 812 includes a local memory 813 (e.g., a cache) and is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 816 may be implemented by flash memory and/or any other desired type of memory device. Access to the main memory 814, 816 is controlled by a memory controller.

The processor platform 800 also includes an interface circuit 820. The interface circuit 820 may be implemented by any type of interface standard, such as an Ethernet interface, a universal serial bus (USB), and/or a PCI express interface.

One or more input devices 822 are connected to the interface circuit 820. The input device(s) 822 permit a user to enter data and commands into the processor 812. The input device(s) can be implemented by, for example, a keyboard, a mouse, a touch screen, a track-pad, a trackball, isopoint and/or a voice recognition system.

One or more output devices 824 are also connected to the interface circuit 820. The output devices 824 can be implemented, for example, by display devices (e.g., a liquid crystal display, a cathode ray tube display (CRT), a printer and/or speakers). The interface circuit 820, thus, typically includes a graphics driver card.

The interface circuit 820 also includes a communication device such as a modem or network interface card to facilitate exchange of data with external computers via a network 826 (e.g., an Ethernet connection, a digital subscriber line (DSL), a telephone line, coaxial cable, a cellular telephone system, etc.).

The processor platform 800 also includes one or more mass storage devices 828 for storing software and data. Examples of such mass storage devices 828 include floppy disk drives, hard drive disks, compact disk drives and digital versatile disk (DVD) drives.

Coded instructions 832 to implement the example processes of FIGS. 6 and 7 may be stored in the mass storage device 828, in the volatile memory 814, in the non-volatile memory 816, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to predict audience composition for future media, comprising:
obtaining indications of intent from first audience members to consume first media;
determining a portion of the first audience members that were actually exposed to the first media; and
predicting audience composition for a second media of second audience members based on the portion of the first audience members.

2. The method as defined in claim 1, wherein predicting audience composition for the second media comprises:
calculating consistency indices for the first audience members, the consistency indices based on verified actual exposures of the first media by the first audience members and total indications of intent to consume the first media by the first audience members over a period of time;
selecting a subset of the first audience members based on the consistency indices; and
predicting the audience composition for the second media based on the consistency indices of the subset of the first audience members.

3. The method as defined in claim 2, wherein calculating the consistency indices includes giving more weight to ones of the actual exposures corresponding to media accessed during a scheduled presenting of the first media than to others of the actual exposures corresponding to media accessed via time-shifted presentations of recorded versions of the first media.

4. The method as defined in claim 2, wherein predicting audience composition includes giving more weight to higher consistency indices and less weight to lower consistency indices.

5. The method as defined in claim 1, wherein predicting audience composition includes predicting at least one of demographic composition or size of an audience for the second media.

6. The method as defined in claim 1, further comprising verifying the actual exposures of the first media by capturing at least one of a code, a signature, or a watermark in at least one of video or audio of the first media via mobile devices of the first audience members.

7. The method as defined in claim 1, further comprising verifying the actual exposures of the first media using metering software executed on media devices presenting the first media.

8. The method defined in claim 1, further comprising processing the indications of intent in real time to predict the audience composition in real time.

9. The method as defined in claim 1, further comprising rewarding a portion of the first audience members that actually accessed the first media.

10. The method as defined in claim 1, wherein the indications of intent to consume are obtained via at least one of a webpage associated with the first media, a webpage associated with media information, a webpage associated with an audience measurement entity, a webpage of a social networking website, a digital video recorder device, a set-top box, a satellite receiver, or a media recognition software application.

11. An apparatus to predict audience composition of future media, comprising:
an audience member interface to obtain indications of intent to consume first media from first audience members;
a verifier to confirm the first media has actually been accessed;
an analyzer to determine a portion of the first audience members that actually accessed the media; and
a predictor to predict the audience composition of second media based on the portion of the first audience members.

12. The apparatus as defined in claim 11, further comprising a consistency index determiner to calculate consistency indices for the first audience members, the consistency indices based on verified actual exposures of the first media by the first audience members and total indications of intent to consume the first media by the first audience members over a period of time, wherein the predictor is to predict the audience composition of the second media of the second audience members based on the consistency indices and a second indication of intent to consume the second media.

13. The apparatus as defined in claim 11, wherein the audience member interface is at least one of a webpage associated with the first media, a webpage associated with media information, a webpage associated with an audience measurement entity, a webpage of a social networking website, a digital video recorder device, a set-top box, a satellite receiver, or a media recognition software application.

14. The apparatus as defined in claim 11, wherein the verifier is to confirm the first media has actually been accessed by capturing at least one of a code, a signature, or a watermark in at least one of video or audio of the first media via mobile devices of the first audience members.

15. The apparatus as defined in claim 11, wherein the verifier is to confirm the first media has actually been accessed by using metering software on media devices presenting the first media.

16. The apparatus as defined in claim 11, wherein the predictor is to predict the audience composition includes predicting at least one of demographic composition or size of an audience for the second media.

17. A tangible machine readable storage medium comprising instructions which, when executed, cause a machine to at least:
obtain indications of intent from first audience members to consume first media;
determine a portion of the first audience members that actually exposed to the first media; and
predict audience composition of a second media of second audience members based on the portion of the first audience members.

18. The tangible article of manufacture as defined in claim 17, wherein predicting audience composition of the second media comprises:
calculating consistency indices for the first audience members, the consistency indices based on verified actual exposures of the first media by the first audience members and total indications of intent to consume the first media by the first audience members over a period of time;
selecting a subset of the first audience members based on the consistency indices; and
predicting the audience composition of the second media based on the consistency indices of the subset of the first audience members.

19. The tangible article of manufacture as defined in claim 17, wherein the machine readable instructions, when executed, further cause the machine to verify the actual exposures of the first media by capturing at least one of a code, a signature, or a watermark in at least one of video or audio of the first media via mobile devices of the first audience members.

20. The tangible article of manufacture as defined in claim 17, wherein the machine readable instructions, when executed, further cause the machine to verify the actual exposures of the first media using metering software executed on media devices presenting the first media.
